(19) United States
(12) Patent Application Publication
(10) Pub. No.: US 2025/0246028 A1
(43) Pub. Date: Jul. 31, 2025

(54) A METHOD AND A SYSTEM FOR MEASURING THE TIME OF A MOVING OBJECT USING A MOBILE DEVICE HAVING A CAMERA INCORPORATED THEREIN AND A TIME MEASUREMENT DEVICE

(71) Applicant: MT SPORT EHF., Gardabaer (IS)

(72) Inventors: Valeriu ANGHEL, Gardabaer (IS); Andrei ANGHEL, Gardabaer (IS)

(21) Appl. No.: 18/854,677

(22) PCT Filed: Apr. 10, 2023
(86) PCT No.: PCT/IB2023/053644

§ 371 Date: Oct. 7, 2024

Related U.S. Application Data
(60) Provisional application No. 63/328,339, filed on Apr. 7, 2022.

(51) Int. Cl. G07C 1/24; G04F 13/02; G06T 7/80

(52) U.S. Cl. CPC G07C 1/24; G04F 13/02; G06T 7/80; G06T 2207/10016

(57) ABSTRACT

A system and method for measuring the time of a moving object during at least one training exercise is disclosed. The system includes a mobile device having a camera and a time measurement computer program. After placing the mobile device in a fixed stationary viewing angle position, the camera is arranged to capture digital images and to enter an image calibration mode, an algorithm calibration mode, and a detection mode before executing a time measuring command on the computer program. The system and method utilize histogram calculation for the digital images to trigger the time measuring command and read object movement detection when threshold values are detected.

### FIELD OF THE INVENTION

The present invention relates to a method and a system of measuring the time of a moving object using a mobile device having a camera incorporated therein and a time measurement device.

### BACKGROUND

Several different types of equipment exist today that are used for time measurement for athletes for training purposes. Most of the equipment on the market require complicated and expensive equipment, such as a laser beam to detect an object (athlete) passing the gate and a software to process the outcoming signals from the laser beam. Existing systems require complex setups and offer limited data accessibility. This obviously leads to limited use by individuals and smaller athlete clubs due to how costly and complicated this equipment is. There is a need for a smart time measurement system that allows coaches to measure a group of athletes, or individual athletes, with minimum effort. There is also a need for a smart time measurement system that allows coaches to instantly see the results and performance of the measured athletes.

### SUMMARY

It is an object of embodiments of the time measurement system to provide an improved method and a system of measuring the time of a moving object. In particular, the objective of the time measurement system is to provide a user-friendly and low-price time measurement solution suitable to be used in mobile applications to measure the time of an athlete passing through one or more gates. is to provide a user friendly and low price time measurement system suitable to be used in mobile applications to measure the time of an athlete passing through one or more gates.

In general, the time measurement system preferably seeks to mitigate, alleviate or eliminate one or more of the above-mentioned disadvantages of the prior art singly or in any combination. In particular, it may be seen as an object of embodiments of the present-time measurement system to provide a method and a system that solves the above-mentioned problems, or other problems.

To better address one or more of these concerns, the first aspect of the time measurement system is a method provided for measuring the time of a moving object using a mobile device having a camera incorporated therein and a time measurement device, the method comprises the steps of: the steps of:
placing the mobile device in a fixed stationary viewing angle position;
setting the camera to enter image calibration mode, comprising:
   capturing digital images,
   processing each of the captured digital images and based thereon determining characteristic image parameters for the camera, and
   setting the determined characteristic image parameters as fixed image-specific parameters;
setting the camera in algorithm calibration mode, comprising:
   capturing a digital image,
   converting the digital image into a numeric value,
   continuously looping through the following sub-steps for a defined time to calibrate the deviation tolerance value,
      capturing a subsequent digital image,
      converting the subsequent digital image into a subsequent numeric reference value,
      repetitively determining a deviation of the subsequent numeric reference value from the previous numeric value until a pre-defined criteria is met, and
      determining a deviation tolerance value; and
setting the camera in detection mode (time measurement mode), comprising:
   capturing a digital image,
   converting the digital image into a numeric value,
   continuously looping through the following sub steps until the measuring device stops the loop,
      capturing a subsequent digital image,
      converting the subsequent digital image into a subsequent numeric value,
      determining a deviation between the subsequent numeric value and the previous numeric value, wherein if the deviation exceeds the deviation tolerance value a time measuring command for the time measurement device is triggered.

Accordingly, a simple and low-cost user-friendly solution is provided suitable for mobile devices where no extra equipment, such as a laser beam, is needed. In one embodiment, the time measuring command for the time measurement device instructs the time measurement device to one or more of the starting a time measurement, stop the time measurement and register time. The step of converting the digital image into a n numeric value includes converting a histogram of the digital image into a histogram value. In one embodiment, the time measuring command for the time measurement device instructs the time measurement device to one or more of the starting a time measurement, stopping the time measurement and registering time, or registering lap time. Lap time is interpreted to mean the time taken to complete a segment or lap of the training exercise. The step of converting the digital image into a numeric value includes converting a histogram of the digital image into a histogram value, but this should not be construed as being limited to this particular method, similar method well known to a person skilled in the art may of course also be utilized.

The step of freezing the characteristic image parameters autofocus (AF), auto-exposure (AE), and auto-white-balance (AWB).

The step of converting the digital image into a numeric value may in one embodiment comprise the following steps:
Catch each frame from the camera preview;
Convert each frame from platform-specific format to an RGB format;
Crop frame to a reduced size or reasonably small image area (e.g., 30×30 px, though it can have any other values depending on the camera, device performance, and preferred parameters);
Histogram calculation (e.g., the implementation described in
https://docs.opencv.org/3.4/d8/dbc/tutorial_histogram_calculation.html; however, the histogram calculation may be implemented using an alternative function for execution); and
Store histogram calculation results in memory.
wherein the above-mentioned steps are repeated on each frame as long as the camera is in calibration mode or detection mode.

In an embodiment, the camera will enter detection mode via an input command from a user. The input command will perform the image calibration and camera calibration before entering the camera detection mode. This may be performed via a speech comment, or a push button or touch button command.

In an embodiment, one device is acting as a primary device that can be connected to a number of other devices to set up exercises with multiple gates. Each additional device is defined as a stop or lap time gate synchronizing the time measurement with the primary device. The method described above, which utilizes a histogram calculation to trigger the time measurement, can also be used to count how often an athlete will pass through the gate. In this feature the device utilizes a count-down or timer function, provided by the computer program, that is set to a predefined time, e.g., 30 seconds. At the Start or initiation of the exercise, the device will subsequently count how often the athlete passes through the gate within the predefined time. At the expiration of the predefined time, the computer program provides on the mobile device a number of repetitions of the laps that the athlete completed during the training exercise, thus providing objective data to athletes, coaches, and other individuals to use as a physical metric that is specific to the athlete.

The camera is preferably calibrated before time measurement is started to optimize object detection in the environment. The camera will in an embodiment constantly detect changes in the environment (e.g., changes in brightness) and adapt parameters to optimize object detection.

Accordingly, an improved time measurement solution is provided where e.g., movements in the background do not affect the time measurement.

In a second aspect of the time measurement system, a mobile device is provided for measuring the time of a moving object after placing the device in a fixed stationary viewing angle position, where the device comprises:
a camera,
a time measurement module,
an image calibration module configured to receive an input command for setting the camera to enter image calibration mode, followed by the steps:
   capturing a digital image,
   processing each of the captured digital image and based thereon determining characteristic image parameters for the camera, and
   setting the determined characteristic image parameters as fixed image-specific parameters,
an algorithm calibration module configured to receive an input command for setting the camera in algorithm calibration mode, followed by the steps:
   capturing a digital image,
   converting the digital image into a numeric value,
   continuously looping through the following sub steps for a defined time to calibrate the deviation tolerance value, followed by the steps:
      capturing a subsequent digital image,
      converting the subsequent digital image into a subsequent numeric reference value,
      determining a deviation of the subsequent numeric reference value from the previous numeric value, and
      repeating steps a. to e. in accordance with a pre-defined criteria, and
      determining a deviation tolerance value, and
a detection mode module for setting the camera in detection mode including time measurement mode, followed by the processing steps of:
   capturing a digital image,
   converting the digital image into a numeric value, and
   continuously looping through the following sub-steps until the measuring device stops the loop, followed by the steps of:
      capturing a subsequent digital image,
      converting the subsequent digital image into a subsequent numeric value, and
      determining a deviation between the subsequent numeric value and the previous numeric value, wherein if the deviation exceeds the deviation tolerance value a time measuring command for the time measurement device is triggered.

In general, the various aspects of the time measurement system may be combined and coupled in any way possible within the scope of the invention. These and other aspects, features, and/or advantages of the time measurement system will be apparent from and elucidated with reference to the embodiments described hereinafter. will be apparent from and elucidated with reference to the embodiments described hereinafter.

### BRIEF DESCRIPTION OF THE DRAWINGS

The drawing figures are not necessarily drawn to scale, but instead are drawn to provide a better understanding of the components thereof, and are not intended to be limiting in scope, but to provide exemplary illustrations. The figures illustrate exemplary configurations of the time measuring system and method, and in no way limit the structures or configurations according to the present disclosure.

Embodiments of the time measuring system and method will be described, by way of example only, with reference to the drawings, in which

FIG. 1 depicts a flow diagram of a method according to the current measurement system,

FIG. 2 illustrates graphically an example of the flow diagram shown in FIG. 1,

FIG. 3 shows and example of camera calculation output, tolerance value, and how an object will trigger the application,

FIG. 4 is a schematic diagram depicting a mobile computing system in accordance with an embodiment of the disclosed time-measuring system,

FIG. 5 illustrates an example display of the graphical user interface used to display an introductory page for interfacing with the disclosed time measuring system,

FIG. 6 illustrates an example display of the graphical user interface used to select a training exercise,

FIG. 7 illustrates an example display of the graphical user interface used to depict a detailed view of a selected training exercise,

FIG. 8 illustrates an example display of the graphical user interface used to display a gate and provide for measuring the time of a moving object, and

FIG. 9 illustrates an example display of the graphical user interface used to display results obtained from the implementation of the time measuring system.

### DEFINITIONS

The term “gate” refers to an optical window comprising a frame, or boundaries, to detect the motion parameters of an object.

The term “histogram” means a numerical data structure that holds the number of several data points within a specified range. The term includes a histogram consisting of a series of numeric values as described above. In particular the term “image histogram” means a graphical representation of the tonal distribution in a digital image. An image histogram plots the number of pixels for each tonal value.

The term “mobile application” is a computer program or software application designed to run on a mobile device.

The term “mobile device” means a portable device with at least an integrated computer and camera, such as a smartphone, tablet, or watch.

Unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

### DETAILED DESCRIPTION OF VARIOUS EMBODIMENTS

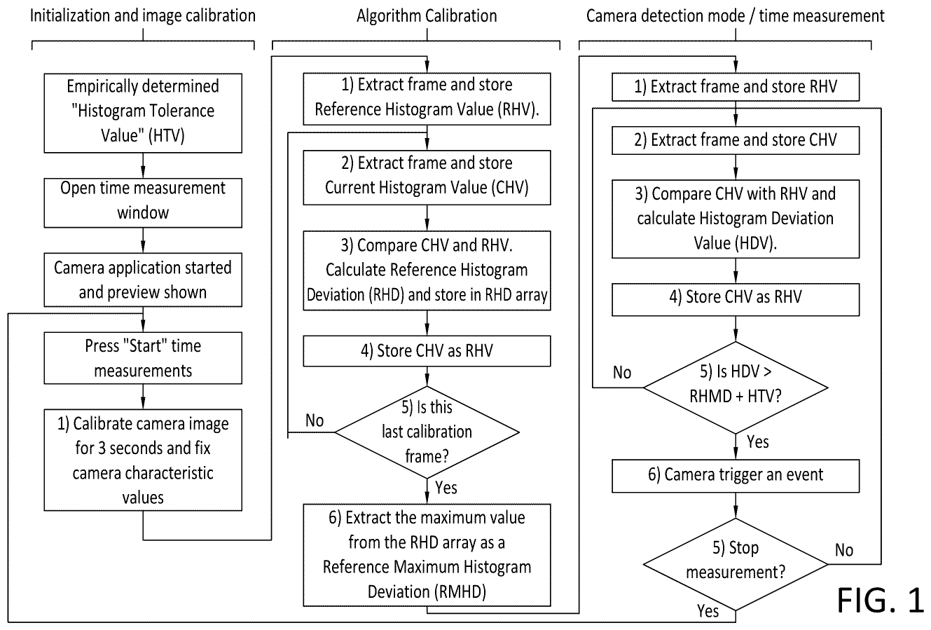

FIG. 1 shows a flow diagram of one embodiment of a method according to the present system of time measurement for any type of a portable device such as a mobile phone where a laser or a beam gate solution can be replaced with a camera of the mobile phone. The mobile phone is set up as a gate where the camera is used to detect moving objects (e.g., running athletes) passing through the gate. As the system comprises a fixed stationary viewing angle position, the gate frame or boundaries are utilized to establish the sequential parameters of start times, lap times, and finish times. Although not required, the system may comprise a stand to stabilize the portable device and fix the gate, or multiple gates, in place. In an embodiment, the system may detect user movements with respect to the portable device (i.e., the movements of the user's hand that are holding the portable device), whereas a first embodiment may ignore the user movements with respect to the portable device. The camera used in the system continuously caches frames of the area where the athlete should pass through.

The camera continuously analyzes the captured frames, and a numeric value is extracted from each frame. Regarding the step of converting the digital image into a numeric value, a preferred embodiment converts each frame from a platform-specific format to an RGB format. In an embodiment, a single channel from the RGB format may be used in the conversion; however, this may decrease the accuracy of extracting the numerical value. It is preferred to utilize more than one channel from the RGB format to increase the viability of the system in practice. It is not outside the scope of the system and method to use an alternative format; however, the RGB format produces satisfactory results and is commonly used in practice. A Current Histogram Value (CHV) and Reference Histogram Value (RHV) are compared, and if the difference in the value is lower than the Reference Maximum Histogram Deviation (RHMD)+Histogram Tolerance Value (HTV), then an event for recording and measuring time is not triggered. Otherwise, the event for recording and measuring time is triggered. In practice, this means that the portable device can be moved “slowly” without triggering the camera and ignore all slow movements. As an example, the portable device may be considered to be moving slowly if moved at an angular speed lower than approximately 1 radian per second or approximately 0.15 revolutions per second. However, one skilled in the art will recognize that a slow speed may vary for different activities and sports, and the system may comprise customized parameters to redefine motion that is slow or insignificant. are compared, and if the difference of the value is lower than the Histogram Tolerance Value (HTV), then an event for recording and measuring time is not triggered. Otherwise, the event for recording and measuring time is triggered. In practice this means that the portable device can be moved “slowly” without triggering the camera and ignore all slow movements.

The working flow can be described by the following steps:

```
The only numerical input for the Algorithm is the Histogram Tolerance Value (HTV) which is an
empirically calculated value and can be platform specific.
The mobile application starts to use the device camera. (The time measurement has not started).
The camera observes the environment and calibrates the image characteristics e.g., focus and
white balance.
The user presses the “Start” button to initiate the time measurement.
Camera Image Calibration
    [Camera Image Calibration starts].
  The camera observes the environment and calibrates image characteristics to have a
  stable preview for image handling in the next stages.
    [Camera Image Calibration ends after approximately 3seconds]
  Output: The camera's characteristics are fixed.
Algorithm Calibration
  The camera captures the first frame, crops it, extracts the image histogram and stores it as
  a Reference Histogram Value (RHV) for the next frame.
    [Algorithm Calibration Loop start].
  The camera captures the current frame, crops it, and extracts the Current Histogram
  Value (CHV).
  The CHV is compared with RHV. A numeric value (Reference Histogram Deviation -
  RHD) is taken from that operation and stored in an array (RHD array).
  CHV is stored as RHV for the next loop.
    [Algorithm Calibration Loop ends after approximately 200 frames]
  The maximum value from the RHD array is stored as Reference Maximum Histogram
  Deviation (RMHD) for the Camera Detection Mode.
    [Algorithm Calibration ends]
    [Loop ends]
  Output: RMHD
Camera Detection Mode (time measurement)
  Input: RHMD and Histogram Tolerance Value (HTV).
  The camera captures the first frame, crops it, extracts the image histogram, and stores it
  as an RHV for the next frame.
  [Continues loop starts]
  The current frame is captured and cropped, and the current histogram is extracted from
  the currently processed frame (CHV).
  The CHV is compared with RHV and a numeric value (called Histogram
  Deviation Value - HDV) is taken from that operation.
  The CHV is stored and used as RHV for the next loop.
  If HDV is greater than RMHD + HTV then an event is triggered.
    The triggered event timestamp is stored.
    The triggered event can control the internal device timer by starting or stopping it
    (depending on application).
    The triggered event puts the Camera Detections Mode into a sleep mode for
    approximately 1500 milliseconds, which means that no other events will be
    triggered during this time interval of 1500 milliseconds. This sleeping mode is
    useful to avoid false triggering while the moving object is still in front of the
    sensor.
```

In an embodiment, the algorithm will not trigger an event in case where the object is moving slowly in front of the camera and/or an object is far away from the camera. This secures that the camera is acting as a gate only triggered when the athlete should pass through the gate and not by “irrelevant” movements.

In an embodiment, a mobile device is provided for measuring the time of a moving object, subsequent to placing the device in a fixed stationary viewing angle position. The mobile device 101 comprises a processor; a camera, a time measurement module, an image calibration module executable by the processor and configured to receive an input command for setting the camera to enter image calibration mode, an algorithm calibration module executable by the processor and configured to receive an input comment for setting the camera in algorithm calibration mode, and a detection mode module executable by the processor and for setting the camera in detection mode including time measurement mode.

The image calibration module is further configured to execute the steps of capturing calibration digital images, processing each of the captured digital images and determining characteristic image parameters for the camera, and setting the determined characteristic image parameters as fixed image-specific parameters. The algorithm calibration module is further configured to execute the steps of capturing an initial digital image, converting the initial digital image into a numeric value, and continuously looping through sub-steps for a defined time to calibrate a deviation tolerance value. The sub-steps for the algorithm calibration module are processed by capturing a subsequent digital image, converting the subsequent digital image into a subsequent numeric reference value, determining a deviation of the subsequent numeric reference value from a previous numeric value, repeating previous steps of the algorithm calibration module in accordance to pre-defined criteria, and determining a deviation tolerance value.

The detection mode module is further configured to execute the steps of capturing a detected digital image, converting the detected digital image into a detected numeric value, and continuously looping sub-steps until it is stopped by the time measurement module. The sub-steps for the detection mode module are processed by capturing a subsequent detected digital image, converting the subsequent detected digital image into a subsequent detected numeric value, and determining a detection deviation between the subsequent detected numeric value and the previous detected numeric value.

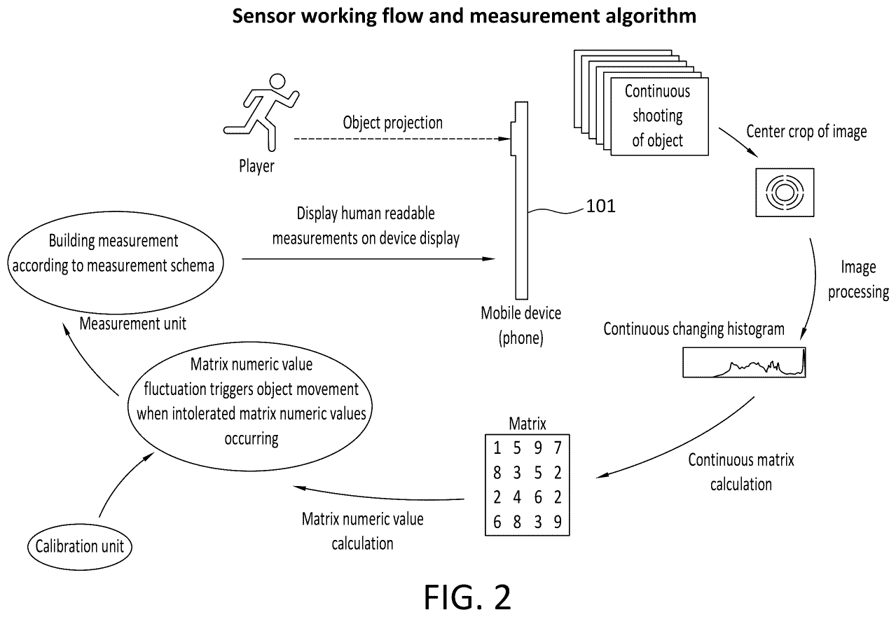

FIG. 2 is a graphical illustration of the flow from detecting an object to displaying the result for the user. As observed, the camera of a mobile device 101 of the timegate system 100 captures an object, or player, in motion. The mobile device 101 continuously captures images of the object and obtains a center cropped image for each image that is captured. The timegate system 100 processes those images and develops a continuously changing histogram by extracting each image histogram and storing it as an RHV for the subsequently captured image. The captured images are converted into numeric values, the numeric values formulating a matrix. Based on the matrix number values and input from the algorithm calibration, the fluctuation in the matrix numeric values triggers a reading of object movement detection when intolerable, or threshold, matrix numeric values are detected. The time measurements for the moving object are constructed based on the programmed measurement schema and subsequently displayed on a screen of the portable device.

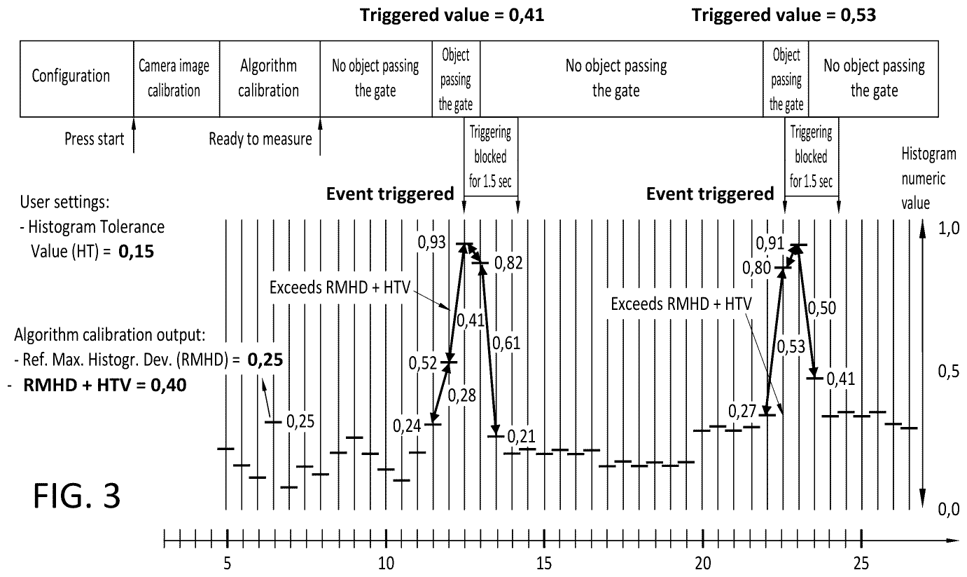

FIG. 3 is a graphical illustration with camera calculation output and how the object (athlete) will trigger the device when passing the camera. After certain physical parameters are configured (e.g., physical parameters corresponding to pre-programmed digital parameters linked to a training exercise), a user presses the ‘Start’ icon displayed on the portable device 101. Upon pressing ‘Start’, the camera image calibration phase occurs for a brief time period, e.g., approximately 3 seconds, followed by the algorithm calibration phase for establishing relevant histogram values linked to the recorded images. Upon completion of the algorithm calibration, the timegate system 100 is prepared to measure and detect a moving object. Once the histogram values exceed a certain threshold, an event is “triggered” to indicate a starting time. The timegate system 100 will continue to record and track “triggered” histogram values and automatically classify the events as laps or store split times, or stop the measurement. Stop measurement will bring the application to “Camera Calibration mode”.

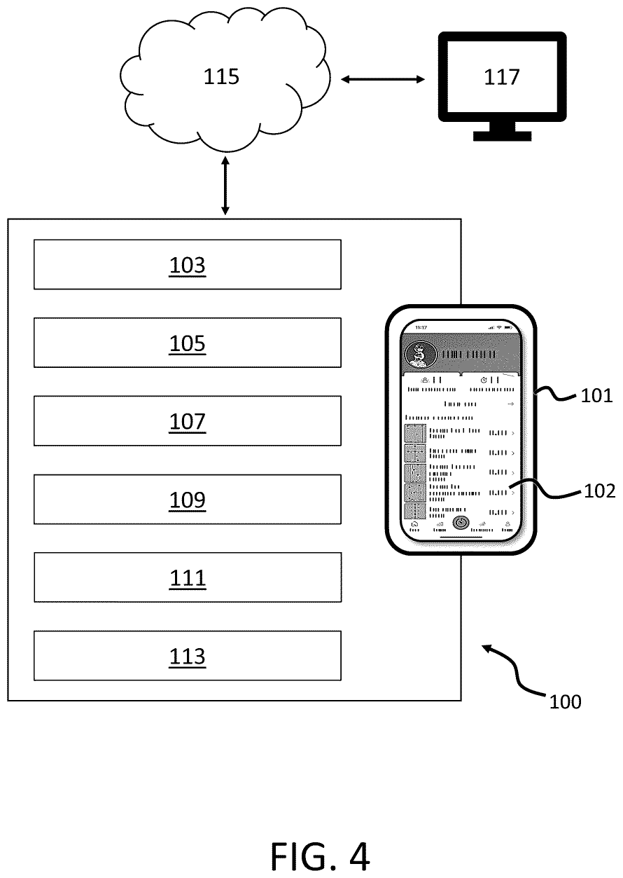

FIG. 4 illustrates a schematic diagram of a timegate system 100 that facilitates the time measurement methods described with respect to FIGS. 1-3. The timegate system 100 comprises a mobile device 101 for measuring the time of a moving object. In an embodiment, the time system 100 is configured as the computer program product. In the depicted embodiment, the mobile device 101 comprises a display system 102, at least one processor 103, an input device 105, an imaging system 107, a computer program 109, storage media 111, and a system memory 113. The display system 102 comprises a screen for displaying a graphical user interface (GUI) that interfaces with the computer program 109. The computer program 109 is configured as a time measurement module. The display system 102 may also include a main display screen having a plurality of graphical display elements and may further include other components of the mobile device 101. The input device 105 comprises interactive means, such as a keyboard, pointing device, mouse, trackball, pen, or touch screen, for interacting with the GUI of the computer program 109 implemented by the display system 102. The imaging system 107 comprises a camera that is coupled to the mobile device 101. The camera of the imaging system 107 captures the motion of a moving object and includes photographic and video recording capabilities. The imaging system 107 is configured as an image calibration module and configured to receive an input command for setting the camera to enter an image calibration mode. The mobile device 101 as depicted further includes a system memory 113 for executing the computer program 109 of the time measurement system. The storage media 111 is illustrated as storing computer-executable instructions implementing at least the time measurement methods described with respect to FIGS. 1-3, the computer-executable instructions being executable by the processor 103.

The mobile device 101 is communicatively coupled to a network 115 for enabling the transfer of computer-readable media. Computer-readable media that carry computer-executable instructions can be used to carry or transmit program code, regarding the disclosed method, in the form of computer-executable instructions or data structures within the timegate system 100 and between the mobile device 101 and external computing system 117. The external computing system 117 may comprise a server, at least one processor, and computer storage media. When information is transferred or provided over a network 115 or another communications connection (either hardwired, wireless, or a combination of hardwired or wireless) to a mobile device 101, the mobile device 101 may view the connection as transmission media. Combinations of the above should also be included within the scope of computer-readable media. In an embodiment, multiple mobile devices 101 are connected via the network 115 in the timegate system 100. This embodiment enables athletes, coaches, parents, and others to share metrics and track performance data. The performance data and metrics may include individualized or team results, comparative analysis of data, and measurement history of data.

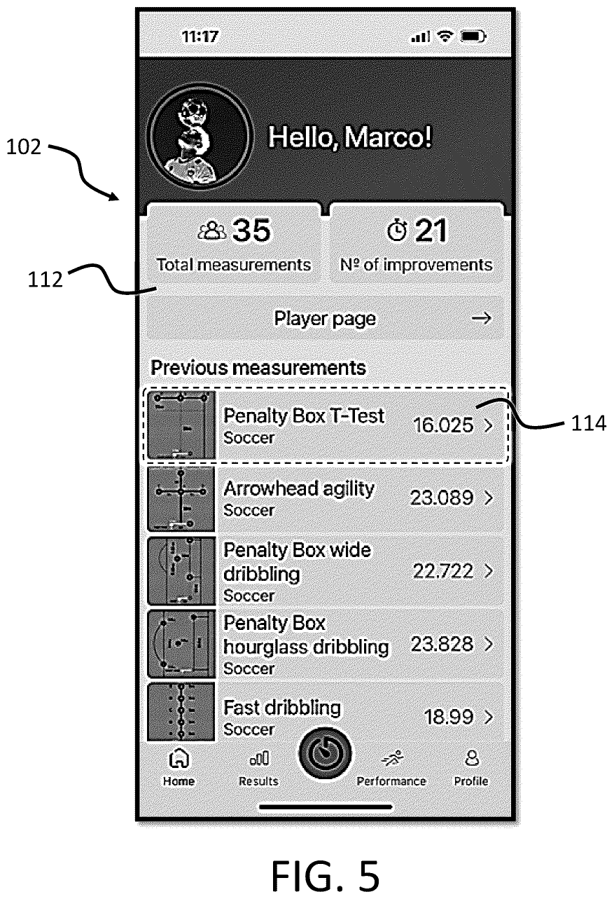

FIGS. 5-9 illustrate exemplary graphical user interfaces of the computer program 109 implemented by the display system 102. FIG. 5 depicts an introductory page 112 for interfacing with the computer program 109. The introductory page 112 comprises at least one icon 114 for interacting with a user and directing the user to, for example, access previous measurements of a training exercise. The introductory page 112 may also comprise icons for accessing a home page, results page, performance page, and user profile page.

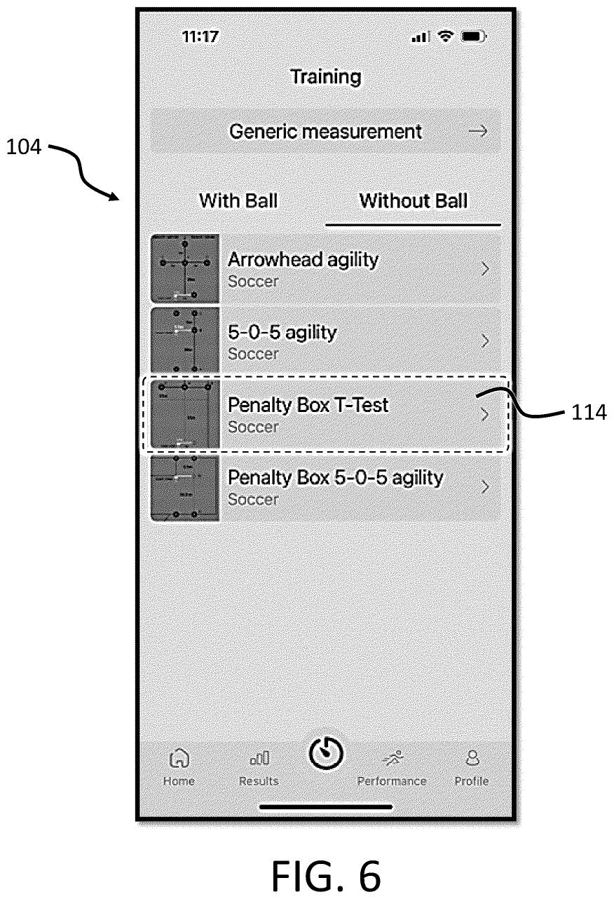

FIG. 6 depicts a training exercise page 104 for interfacing with the computer program 109. The training exercise page 104 comprises at least one icon 114 for selecting a training exercise for a user to conduct in accordance with the disclosed method described with respect to FIGS. 1-3. The training exercise page 104 may comprise an icon to select a training exercise with a sports object, such as a ball, and without a sports object.

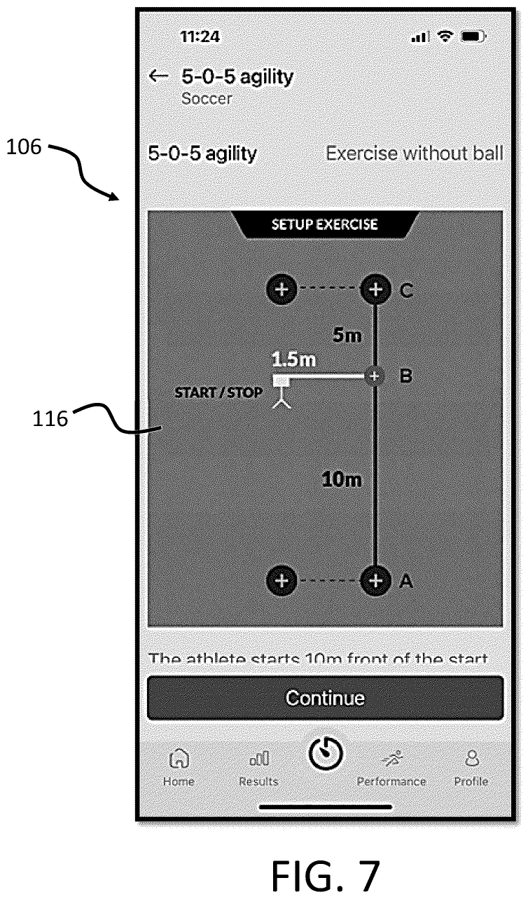

FIG. 7 depicts a training exercise page 106 for interfacing with the computer program 109. The training exercise page 106 may comprise specific detail regarding the instructions for an athlete or user to perform the training exercise. The training exercise page 106 comprises a graphical representation 116 of a specific training exercise, the graphical representation 116 depicting a setup of the training exercise. The graphical representation 116 indicates positional details, such as distance, placement of markers or cones, location of the mobile device 101, and direction of the camera viewing angle for detecting an objection in motion.

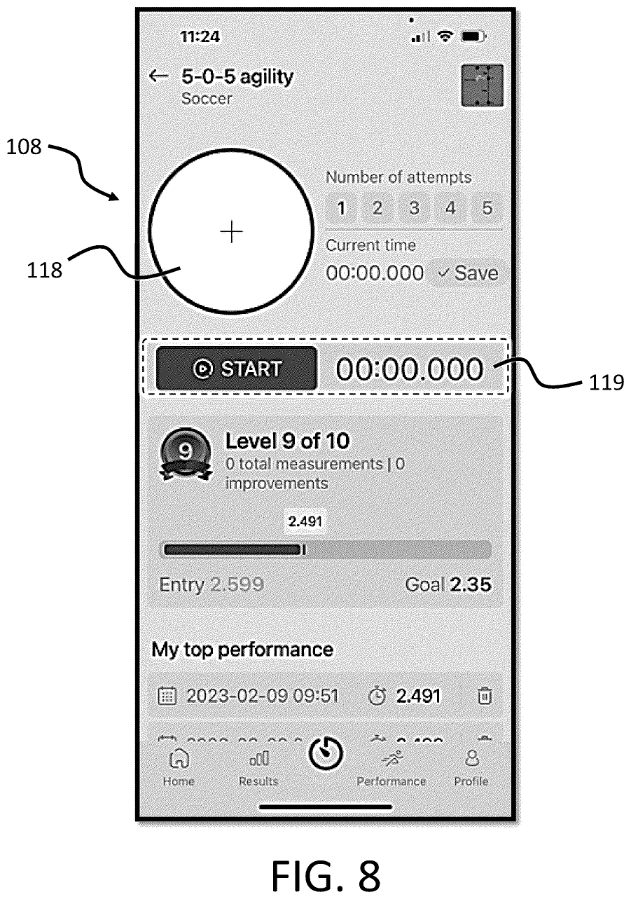

FIG. 8 illustrates a time measurement interface page 108 for an exemplary training exercise. The time measurement interface page 108 comprises a viewing window display 118 that displays a frame, or gate, of the area being recorded by the imaging system 107 is output to the display system 102. The time measurement interface page 108 comprises an icon 119 for initiating the time system 100 to perform the method described with respect to FIGS. 1-3. In an embodiment, this method is also used to calculate the frequency or number of times that an athlete passes through the gate. Using a single mobile device 101, the display system 102 can provide a count-down or timer that is set at a predefined time, e.g., 30 seconds, and the processor 103 can execute instructions provided by the computer program 109 to measure how often the athlete passes through the gate, or window display 118, within the predefined time. The results provided by this embodiment can provide the lap times for each training exercise. Alternatively, more than one mobile device 101 can be placed at different locations and configured to measure lap times at different gates of a training exercise. A mobile device 101 can act as a primary device that communicates and is connected to a number of other mobile devices, wherein each additional device defines a stop or lap time gate and synchronizes the time measurement with the primary device.

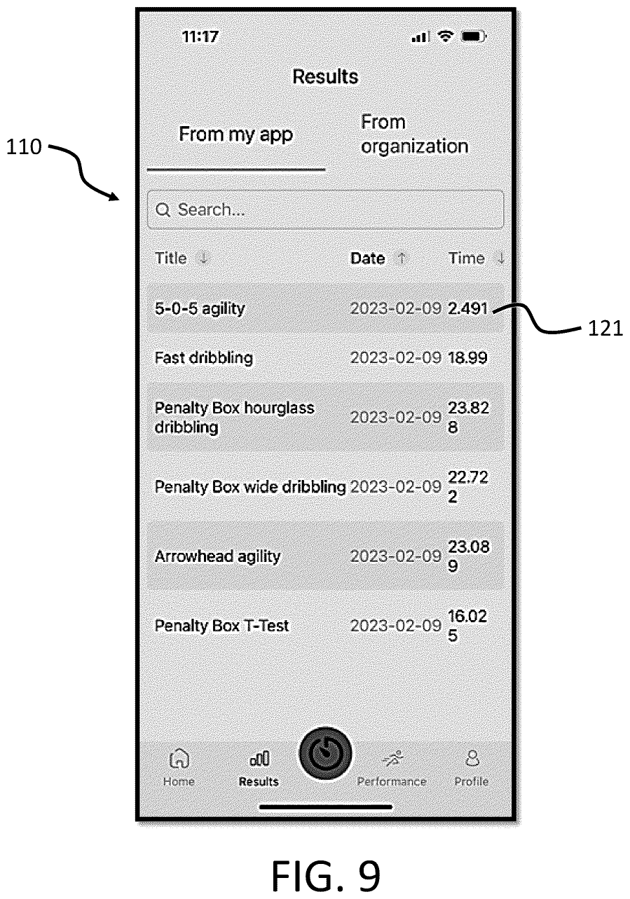

FIG. 9 illustrates exemplary results page 110 for at least one training exercise of the computer program 109, displaying a performance time 121 for at least one training exercise. The results page 110 may include results stored in connection with the computer program 109 on the mobile device 101 and also include results from an organization or team stored in connection with the network 115 and external computing system 117.

While the time measurement system has been illustrated and described in detail in the drawings and foregoing description, such illustration and description are to be considered illustrative or exemplary and not restrictive; the time measurement system is not limited to the disclosed embodiments. Other variations to the disclosed embodiments can be understood and effected by those skilled in the art in practicing the claimed time measurement system, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to an advantage.

It is to be understood that not necessarily all objects or advantages may be achieved under any embodiment of the disclosure. Those skilled in the art will recognize that the timegate system, method, or device may be embodied or carried out in a manner that achieves or optimizes one advantage or group of advantages as taught herein without achieving other objects or advantages as taught or suggested herein. It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The skilled artisan will recognize the interchangeability of various disclosed features. Besides the variations described herein, other known equivalents for each feature can be mixed and matched by one of ordinary skill in this art to build and use the time measurement system under the principles of the present disclosure. It will be understood by the skilled artisan that the features described herein may be adapted to other methods and types of time measurement devices and applications.

It is intended that the present disclosure should not be limited by the disclosed embodiments described above and may be extended to other applications that may employ the features described herein.

1.-20. (canceled)

21. A method, implemented on a mobile device comprising a processor, a computer program, and a camera, for measuring time of a moving object during performance of at least one training exercise, the method comprising the steps of:
placing the mobile device in a fixed stationary viewing angle position;
setting the camera to enter an image calibration mode of the computer program;
setting the camera to enter an algorithm calibration mode of the computer program;
setting the camera in a detection mode of the computer program; and
executing a time measuring command on the computer program to measure the time of the moving object during performance of the at least one training exercise;
wherein the step of setting the camera to enter the image calibration mode subsequently includes:
capturing at least one digital image for image calibration,
processing each captured digital image,
determining characteristic image parameters for the camera, and
setting the determined characteristic image parameters as fixed image-specific parameters;
wherein the step of setting the camera to enter the algorithm calibration mode subsequently includes:
capturing a digital image for algorithm calibration,
converting the digital image into a numeric value, wherein the numeric value is a histogram value obtained from a histogram of the digital image captured for algorithm calibration, and
continuously looping through following sub-steps for a predefined time to calibrate a deviation tolerance value:
capturing a subsequent digital image,
converting the subsequent digital image into a subsequent numeric reference value,
repetitively determining a deviation of the subsequent numeric reference value from a previous numeric value until a pre-defined criteria is met, and
determining the deviation tolerance value;
wherein the step of setting the camera in the detection mode subsequently includes:
capturing a digital image for the detection mode,
converting the digital image into a numeric value, wherein the numeric value is a histogram value obtained from a histogram of the digital image captured for the detection mode,
continuously looping through the following sub-steps until a deviation between the subsequent numeric value and the previous numeric value exceeds the deviation tolerance value, the following sub-steps including:
capturing a subsequent digital image,
converting the subsequent digital image into a subsequent numeric value, and
determining a deviation between the subsequent numeric value and the previous numeric value; and
wherein the time measuring command for execution on the mobile device is triggered after the deviation exceeds the deviation tolerance value.

22. The method according to claim 21, wherein the time measuring command instructs the computer program to perform one or more of the following:
start a time measurement of the at least one training exercise,
stop the time measurement and register time of the at least one training exercise, and
register lap time of the at least one training exercise.

23. The method according to claim 21, wherein the at least one training exercise comprises sequential parameters of a start time, a lap time, and a finish time defined by gate boundaries of the camera at the fixed stationary viewing angle position.

24. The method according to claim 21, wherein the numeric value forms part of a matrix, and wherein fluctuation in numeric values of the matrix triggers a reading of object movement detection when threshold matrix numeric values of the matrix are detected.

25. The method according to claim 21, wherein the step of converting the digital image into a numeric value comprises the following steps:
catching each frame from a camera preview;
converting each frame from to an RGB format;
cropping each frame to a reduced image size;
calculating the histogram value based on each frame; and
storing the histogram value in a system memory of the mobile device.

26. The method according to claim 25, wherein the steps of catching each frame from the camera preview, converting each frame from to the RGB format, cropping each frame to the reduced image size, calculating the histogram value based on each frame, and storing the histogram value in the system memory are repeated on each frame while the camera is in the image calibration mode, algorithm calibration mode, or the detection mode.

27. The method according to claim 21, wherein the camera is configured to enter the detection mode after receiving an input command from a user, wherein the camera enters image calibration mode and camera calibration mode after receiving the input command from the user and before entering the detection mode.

28. The method according to claim 21, wherein the mobile device acts as a primary device configured to connect with a number of other devices to set up exercises with multiple gates; and wherein each of the other devices is defined as a stop or lap time gate synchronizing the time measurement with the primary device.

29. A mobile device for measuring time of a moving object during performance of at least one training exercise, subsequent to placing the device in a fixed stationary viewing angle position, the mobile device comprising:
a processor;
a camera configured to capture digital images;
a mobile application including an image calibration module, an algorithm calculation module, and a detection mode module;
wherein the mobile application is configured to process the digital images and generate a continuously changing histogram by extracting an image histogram from each digital image and storing the image histogram as a reference histogram value for each subsequently captured digital image; and
wherein the mobile application is configured to trigger a time measuring command based on the continuously changing histogram to measure the time of the moving object during the performance of the at least one training exercise.

30. The mobile device according to claim 29, wherein the image calibration module is configured to set the camera into an image calibration mode and is further configured to:
capture digital images for calibration,
process each of the captured digital images and determining characteristic image parameters for the camera, and
set the determined characteristic image parameters as fixed image-specific parameters.

31. The mobile device according to claim 29, wherein the algorithm calibration module is configured to set the camera into an algorithm calibration mode and is further configured to determine a deviation tolerance value by:
capturing a digital image for algorithm calibration,
converting the digital image into a numeric value, wherein the numeric value is a histogram value obtained from the continuously changing histogram of the digital image captured for algorithm calibration, and
continuously looping through following sub-steps for a predefined time to calibrate a deviation tolerance value:
capturing a subsequent digital image,
converting the subsequent digital image into a subsequent numeric reference value,
repetitively determining a deviation of the subsequent numeric reference value from a previous numeric value until a pre-defined criteria is met, and
determining the deviation tolerance value;

32. The mobile device according to claim 29, wherein the detection mode module is configured to set the camera into a detection mode for the camera and is further configured to determine a detection deviation by:
capturing a detected digital image,
converting the detected digital image into a detected numeric value,
continuously looping through the following sub-steps until stopped by the mobile application, the following sub-steps being:
capturing a subsequent detected digital image,
converting the subsequent detected digital image into a subsequent detected numeric value, and
determining the detection deviation between the subsequent detected numeric value and a previously detected numeric value.

33. The mobile device according to claim 29, wherein the mobile application includes a graphical representation of the at least one training exercise, the graphical representation depicting a setup of the training exercise to indicate at least one of the following positional details:
placement of markers for completing the at least one training exercise;
location of the mobile device; and
direction of the camera for detecting the moving object.

34. The mobile device according to claim 29, wherein the mobile application includes a gate defining an area being recorded by the camera, the gate being displayed on the mobile device on a graphical user interface.

35. The mobile device according to claim 29, further arranged as a primary device configured to connect with a number of other devices to set up the at least one training exercise with multiple gates, and wherein each of the other devices is defined as a stop or lap time gate for synchronizing the time measurement with the primary device.
